(19) United States
(12) Patent Application Publication
(10) Pub. No.: US 2001/0047271 A1
(43) Pub. Date: Nov. 29, 2001

(54) Method and system for building a content database

(76) Inventors: Daniel Jason Culbert, Sunnyvale, CA (US); Denis Gulsen, Redwood City, CA (US)

Correspondence Address: Daniel Culbert, 1035 Aster Ave #2196, Sunnyvale, CA, 94086, US

(21) Appl. No.: 09/790,777

(22) Filed: Feb. 23, 2001

Related U.S. Application Data
(60) Provisional application No. 60/183,939, filed on Feb. 22, 2000.

(51) Int. Cl. G06F 7/00

(52) U.S. Cl. 705/1; 707/1

(57) ABSTRACT

This is a system and method for growing an internet-based database.

### INVENTORS

Daniel Culbert; Palo Alto, Calif. Denis Gulsen; Palo Alto, Calif.

### TECHNICAL FIELD

This invention relates generally to the Internet and other integrated systems and networks for processing information and more particularly to web-based systems and methods for datamining and data transformation.

### BACKGROUND ART

Several new techniques and systems for processing, archiving, and retrieving information have been developed with the proliferation of the Internet. Some of these developments are described in published documents.

In U.S. Pat. No. 6,014,647, Nizzari et al. describe a method for processing transaction data to provide easy access to customer interaction information which may not have been otherwise available or easily accessible. Mining stored information related to interactions with a customer produces personalized customer information that is stored in an interaction database. The personalized customer information is retrieved from the interaction database and used while interacting with the customer. The invention also provides a method for customized interaction processing. The structure of data stored the interaction database and rules are specified by meta data. The invention also provides a method for arranging references to stored interaction information in multiple disparate databases.

In U.S. Pat. No. 5,963,949, Gupta et al. describe a method for data gathering around forms and search barriers. Methods are described for gathering data around forms having one or more fields, enabling a wrapper program to extract semistructured information by determining combinations of values for fields associated with particular forms, submitting the particular forms repeatedly for all combinations of interest, and providing the results returned for further processing. In certain embodiments, the combinations of values for fields is a Cartesian product of the possible values for the fields. Values to be submitted in the form fields may be specified by using a programming language such as Site Description Language (SDL) or Java.

In U.S. Pat. No. 6,006,225, Bowman et al. describe a technique for refining search queries by the suggestion of correlated terms from prior searches. A search engine is disclosed which suggests related terms to the user to allow the user to refine a search. The related terms are generated using query term correlation data which reflects the frequencies with which specific terms have previously appeared within the same query. The correlation data is generated and stored in a look-up table using an off-line process which parses a query log file. The table is regenerated periodically from the most recent query submissions (e.g., the last two weeks of query submissions), and thus reflects the current preferences of users. Each related term is presented to the user via a respective hyperlink which can be selected by the user to submit a modified query. In one embodiment, the related terms are added to and selected from the table so as to ensure that the modified queries will not produce a NULL query result.

In U.S. Pat. No. 5,960,435, Rathmann et al. describe a method and system for computing histogram aggregations. A data record transformation that computes histograms and aggregations for an incoming record stream. The data record transformation computes histograms and aggregations in one-step, thereby, avoiding the creation of a large intermediate result. The data record transformation operates in a streaming fashion on each record in an incoming record stream. Little memory is required to operate on one record or a few records at a time. A method, system, and computer program product for transforming sorted data records is described. A data transformation unit includes a binning module and a histogram aggregation module. The histogram aggregation module processes each binned and sorted record to form an aggregate record in a histogram format in one step. Data received in each incoming binned and sorted record is expanded and accumulated in an aggregate record for matching group-by fields. Also described is a method, system, and computer program product for transforming unsorted data records. An associative data structure holds a collection of partially aggregated histogram records. A histogram aggregation module processes each binned record to form an aggregate record in a histogram format in one step. Input records from the unordered record stream are matched against the collection of partially aggregated histogram records and expanded and accumulated into the aggregate histogram record having matching group-by fields.

In U.S. Pat. No. 5,943,667, Aggarwal et al. describe a technique for eliminating redundancy in generation of association rules for on-line mining. A computer method is disclosed for removing simple and strict redundant association rules generated from large collections of data. A compact set of rules is presented to an end user which is devoid of many redundancies in the discovery of data patterns. The method is directed primarily to on-line applications such as the Internet and Intranet. Given a number of large itemsets as input, simple redundancies are removed by generating all maximal ancestors, the frontier set, for each large itemset. The set of maximal ancestors share a hierarchical relationship with the large itemset from which they were derived and further satisfy an inequality whereby the ratio of respective support values is less than the reciprocal of some user defined confidence value. The resulting compact rule set is displayed to an end user at some specified level of support and confidence. The method is also able to generate the full set of rules from the compact set.

In U.S. Pat. No. 5,933,818, Kasravi et al. describe an autonomous knowledge discovery system and method. The system includes a data reduction module which reduces data into one or more clusters. This is accomplished by the use of one or more functions including a genetic clustering function, a hierarchical valley formation function, a symbolic exspansion reduction function, a fuzzy case clustering function, a relational clustering function, a K-means clustering function, a Kohonen neural network clustering function, and a minimum distance classifier clustering function. A data analysis module autonomously determines one or more correlations among the clusters. The correlations are associated with knowlege.

In U.S. Pat. No. 5,826,260, Byrd, Jr. et al. describe an information retrieval system and method for displaying and ordering information based upon query element distribution. With the described system, a query issued by the user is analyzed by a query engine into query elements. After the query has been evaluated against the document collections, a resulting hit list is presented to the user, e.g., as a table. The presented hit list displays an overall rank of a document and a contribution of each query element to the rank of the document. The user can reorder the hit list by prioritizing the contribution of individual query elements to override the overall rank and by assigning additional weight(s) to those contributions.

In U.S. Pat. No. 5,742,811, Agrawal et al. describe a method and system for mining generalized sequential patterns in a large database. The technique first identifies the items with at least a minimum support, i.e., those contained in more than a minimum number of data sequences. The items are used as a seed set to generate candidate sequences. Next, the support of the candidate sequences are counted. The technique then identifies those candidate sequences that are frequent, i.e., those with a support above the minimum support. The frequent candidate sequences are entered into the set of sequential patterns, and are used to generate the next group of candidate sequences. Preferably, the candidate sequences are generated by joining previously found frequent candidate sequences, and candidate sequences having a contiguous subsequence without minimum support are discarded. In addition, the technique includes a hash-tree data structure for storing the candidate sequences and memory management techniques for performance improvement.

In U.S. Pat. No. 5,732,218, Bland et al. describe a management data gathering system for gathering on clients and servers data regarding interactions between the servers, the clients, and users of the clients during real use of a network of clients and servers. Data gathered on the server includes: number of page accesses per unit of time, durations of delays between receipt of client requests for information and the server responses thereto, number of accesses to each accessed page from each referring page, number of page accesses per browser type, processor and mass-storage occupancy of the server, and configuration details of each accessing browser. Data gathered on the client includes: durations of delays between the client placing a request and a server's response to the request, the amount of time that a particular object is active at the client, abandon count and time, click-ahead count and time, and client demographics. The service management system uses the gathered data to generate reports for a manager of the information service.

What is needed is a relatively small database capable of using information available on the World Wide Web (hereinafter “the web”) to grow itself accurately and efficiently. While some “web mining” or “web crawling” technologies, such as ProspectMiner from Intarka, Inc. (www.intarka.com), are available for using keywords to grow the content of databases, there are no solutions for continually distilling the content of available web pages and growing a useful database or knowledgebase via the browsing activity of actual users. In a co-filed U.S. Patent Application for “Method and System for Distilling Content” by the same inventors, incorporated by reference in its entirety, a system and method for distilling the content of web pages is disclosed. Such techniques are leveraged with the subject invention, a database growing technique which, through the browsing activity of actual users, continually adds depth and breadth to a web-based catalogue of associated specific aggregate nodes and tag/value pairs.

### SUMMARY OF THE INVENTION

This is a method for growing an internet-based database.

### DETAILED DESCRIPTION

The internet is a collection of information storage devices and processors disparately located and connected electronically to each other by network conduits comprising physical elements, such as fiber optic cables, or wireless technology which enables devices to communicate without physical contact. Users of the internet typically find information using browser software, such as Microsoft Internet Explorer or Netscape Navigator, which is configured to navigate a text-based version of the internet called the worldwide web (hereinafter “the web”) by reading and downloading information such as text, which is generally made available by programmers in HTML (hypertext markup language) format.

Browser software typically is installed on a user's local information system, such as a personal computer or personal data assistant (“PDA”), which has temporary memory, such as random access memory (or “RAM”), more permanent storage capacity, such as that provided by a hard disk drive, a locally installed information processing device such as a Pentium(TM) microprocessor, and an internet connectivity device such as a modem. The internet connectivity device generally is configured to establish electronic contact between a local information system and a remotely located device, such as a modem bank of an internet service provider, which bridges the electronic connection of the local information system to other systems connected via the internet.

When a user browses the web from a local information system, information from remote systems is transferred (or “downloaded”) from the remote systems to his local system, often in HTML format. The user's locally installed browser software is configured to display a web “page” based upon the content of the downloaded information, which may comprise text, pictures, movie clips, music clips, and other elements known in the art of web design.

A key aspect of browsing the web is telling the browser software where to seek information which may subsequently be downloaded to the user's local information system. Browser software, such as Microsoft Internet Explorer and Netscape Navigator, is generally configured to provide the user with several options for navigating. Depending upon the content programmed into the particular web page, the user may be provided with “links” which are configured to download content associated with such links to the user's computer. Each link is associated with a uniform resource locator, or URL, which is a brief instruction set pointing to the desired information. Links are generally displayed on a web page using a standard bold/underlined format in a particular color, such as blue, designed to communicate to the user that he will receive content associated with the link by “clicking” on the link using his pointing device (such as a mouse or other pointing device known to those skilled in the art of personal information system design).

Most browser software also allows users to directly input URL text for download of the associated information without the step of clicking on a link.

When a user uses a typical “search engine” to find desired content, he generally enters text keywords, activates a search, and receives a list of links in return, the links being associated with URLs.

In short, browsing the web comprises using an URL to download information, generally comprising text, from a remote information system to a local information system. The inventors of the present invention have described techniques for distilling the content of web pages to XML and other formats which may be loaded into databases in the cofiled U.S. Patent Application for “Method and System for Distilling Content”, which is incorporated by reference in its entirety. The present invention comprises database-building applications of the incorporated content distillation techniques.

The inventive database preferably comprises groupings of “tag/value pairs”. A “tag” represents a variable for which a value is a particular word or phrase. For example, if a user has browsed to a single item page at Amazon.com for the book “John Grisham, The Firm”, several tags are likely to be relevant, such as author, title, ISBN (an international book identification number), and price. In this particular example, the value for the tag “author” would be “John Grisham”, and the value for the tag “title” would be “The Firm”. The grouping of “tag(author)/value(John Grisham); tag(title)/value(The Firm); tag(ISBN)/value(044021145X)” is very likely to be associated with the book.

One variation of this invention allows a user to build a database of values for a given tag iteratively using any content available on the web and some seed values for the given tag. An example is helpful for illustrating this variation. If a user wanted to find all of the values associated with the tag “color” across the entire web, he would spend a lot of time browsing through content. The user probably knows of several values for the tag “color”, such as “red”, “green”, “blue”, “orange”, etc. Indeed, the user can probably create a pattern for locating other colors, such as “______ is a color”. Using the pattern matching scripts or regular expressions and page content downloading technology similar to that described in the cofiled content distillation application, a software algorithm could be developed to extract terms fitting the location of the blank in the pattern, and most of them would be colors. This process, however, still requires that a user creatively think of a value extraction pattern which could successfully be used to “datamine” other colors from web-based content. Other possible value extraction patterns for the tag “color”, for example, might include “______ in color ______”, “shade of ______”, or “following colors: ______”.

It is highly desirable to automate this process to a further extent and allow the user to merely seed the database with a few values for a given tag (“red”, “green”, “blue”, and “orange”, for the tag “color”, for example) and let the invention create value extraction patterns to search the web for other colors. In one variation of the invention, value extraction patterns are developed iteratively by using the seed values in the following fashion:

a. search the web for content having the term “red” and capture the text surrounding this term using a regular expression; do the same for the term “green”, the term “blue”, and the term “orange”;

b. analyze the captured sets of text for similarities across the various seed values; such analysis might, for example, result in the observation of the similar phrases “red is a color”, “blue is a color”, and “green is a color”;

c. store the pattern “______ is a color” as a potential value extraction pattern (as well as any other patterns which are noted as crossover patterns from value to value);

d. use the stored value extraction patterns to extract yet more values for the tag “color” (i.e., use a regular expression to gather terms fitting the blank in the “______ is a color” extraction pattern); if the same value for the tag “color” turns up an experimentally significant number of times, this value (say “mauve”, for example) should be stored on the evergrowing database as a tested value for the tag “color”;

e. continue to seek other potential value extraction patterns and continue to use them to gather a larger set of values for the tag “color”;

f. after many cycles, the analysis will not only result in a large database of values for the tag “color”, but also will result in at value extraction patterns known by experimentation to be successful at extracting values for a given tag.

In another variation, a user of the procedure may be able to intervene and manually “de-select” certain values for a given tag (“Chrysler” as a value for the tag “animal”, for example). This manual “interference” with the iterative process described above may result in significant efficiency gains, since the process will be given the benefit of human knowledge without having to statistically eliminate certain values by experimentation.

1. A method for iteratively growing the number of values associated with a given tag in a database of tag/value pairs comprising:
a. searching the web for textual content surrounding seed values and capturing said textual content using a regular expression;
b. analyzing said textual content for value extraction patterns similar in the textual content returned for different seed values;
c. storing a value extraction pattern;
d. applying the value extraction pattern to extract values from content available on the web using regular expressions taylored to pattern match and extract the proper values;
e. storing repeated values in the database as values associated with the given tag;
f. continuing to seek other value extraction patterns and continuiing to use them to gather a larger set of values for the given tag.
